(19) United States
(12) Patent Application Publication
(10) Pub. No.: US 2009/0101586 A1
(43) Pub. Date: Apr. 23, 2009

(54) ADSORPTION OF RADIONUCLIDES

(75) Inventors: Burkhard BRINGS, Koln (DE); Reinhold KLIPPER, Koln (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, Leverkusen (DE)

(21) Appl. No.: 12/196,304

(22) Filed: Aug. 22, 2008

(30) Foreign Application Priority Data
Aug. 30, 2007 (DE) 102007041361.2

(51) Int. Cl. C02F 1/42; C02F 103/34

(52) U.S. Cl. 210/682

(57) ABSTRACT

The present application relates to a process for the adsorption of radionuclides from media, preferably waters or aqueous solutions, as arise, for example, in nuclear plants, preferably nuclear power plants, by contacting the medium to be treated, preferably water or aqueous solutions, with a mixed bed which is provided additionally with at least one covering layer of a monodisperse, macroporous ion exchanger having a median bead diameter smaller than the ion exchanger used in the mixed bed.

### CROSS REFERENCE TO RELATED PATENT APPLICATIONS

The present patent application claims the right of priority of German Patent Application DE 10 2007 041 361.2 filed on 30 Aug. 2007.

The present application relates to a process for the adsorption of radionuclides from media, preferably waters or aqueous solutions, as arise, for example, in nuclear plants, preferably nuclear power plants, by contacting the medium to be treated, preferably water or aqueous solutions, with a mixed bed which is provided additionally with at least one covering layer of a monodisperse, macroporous ion exchanger having a median bead diameter smaller than the ion exchanger used in the mixed bed.

Media for the purposes of the present invention are solvents in which radionuclides can dissolve. These can be organic solvents or aqueous solutions. Preferably the present process is used for water and radionuclides dissolved therein, particularly preferably aqueous solutions of same. These media can be in the form of cooling water, condensate water or waste water of nuclear plants or plants where radionuclides arise. Nuclear plants, in the context of the present invention, are taken to mean nuclear power plants, reprocessing plants, nuclear enrichment plants or medical facilities where radionuclides are employed. According to the invention, particularly preferably the present process and the device according to the invention are used in the primary circuit of nuclear power plants.

The use of mixed beds for the treatment of water in nuclear reactors has been described several times. U.S. Re. Pat. No. 34 112 describes the reduction of colloidally dissolved iron in the condensate water of a nuclear reactor by contacting said condensate water with a mixed-bed ion exchange resin, in which the cation resin has what is termed a core/shell morphology and the anion resin is produced from gel-type polymer beads having core/shell structure.

DE 43 38 851 A1 describes the treatment of ABC-contaminated waters to produce drinking water by means of wet-oxidation processes combined with a membrane process. The use of mixed bed ion exchangers is emphasized therein as particularly effective for separating off A and C residual contamination.

DE 197 47 076 A1 discloses a process and a device for separating off ⁷Li or boron from the primary cooling circuit of a nuclear power plant. However, here an ion exchanger mixed bed is not proposed for depletion of radioisotopes, but rather for producing the conductivity of the medium by enrichment With ions. The enrichment of the ion exchangers in the mixed bed with radioisotopes and therefore the removal from a medium such as water is rather unwanted in this process of DE 197 47 076 A1.

U.S. Pat. No. 5,308,876 discloses an ion exchanger having a regenerable cation exchange resin (the H form) and a regenerable anion exchange resin (the OH form), which are particulate organic polymeric adsorbents for adsorbing and removing suspended impurities which are present in trace amounts in the water to be treated and principally comprise metal oxides. U.S. Pat. No. 5,308,876 emphasizes the use of the ion exchangers as mixed bed for removing the crud iron such as can occur in nuclear reactors.

Finally, at the EPRI Low Level Redwaste Conference in June 2005, Terry Heller presented the action of macroporous ion exchange resins on the purification of radionuclides. The high-performance cation resins presented in this case and also high-porosity anion resins and mixed beds are, or comprise, only heterodisperse ion exchangers.

Moreover, product brochures recommend the use of mixed beds for condensate treatment generally in conventional power plants. At http://www.cwggmbh.de/produkte/ionenaustauscherharze/stark_kation.htm, for example Amberjet® 1500H, a uniform (monodisperse) gel exchanger is proposed for use in mixed beds for condensate treatment inter alia in power plants. However, Lanxess Deutschland GmbH also offers, for example, Lewatit® MonoPlus M 500 KR or Lewatit® MonoPlus S100 KR for condensate treatment of nuclear plants as “nuclear resins” (see http://www.tas.co.yu/pr01e.htm).

However, it is extremely desirable to keep the radiation dose to which the personnel, for example, in a nuclear power plant are exposed low. A large part of this radiation-dose is absorbed when overhaul, maintenance and repair processes are performed, when the nuclear power plant is shut down, during which the personnel are exposed, inter alia, to radiation during work on pumps, lines and the like of a reactor water circuit outside the reactor core. The reason for this is that radioactive corrosion products is deposited on the surfaces of system particles outside the actual core. ⁶⁰Co is responsible for the majority in absolute terms of the radioactive radiation which originates from these corrosion products. ⁶⁰Co, in addition, has a half life of 5.3 years, which means it is virtually impossible to decrease the height of the radioactive radiation by allowing the personnel to carry out the work only after the reactor has been shut down for a certain time period.

In the reactor water circuit (primary circuit) and in the feedwater circuit, the water causes separation of small amounts of material of various components with which it comes into contact. A large part of these components comprises stainless steel from which iron, nickel and small amounts of cobalt dissolve in the form of ions and particles. In relatively old plants, components are present in the reactor water circuit and feedwater circuit, such as, for example, valves which comprise cobalt, which increase the amount of deposited cobalt. The metals which pass in this manner into the reactor water and the feedwater are deposited as oxides, termed “crud”, on surfaces in the circuit. The crud coating on the surfaces comprises various types of metal oxides and these, as they for example are situated on cladding tubes for nuclear fuel, are exposed to strong neutron radiation. In this process the metal atoms in the crud coating are transformed into nuclides, of which a part is radioactive. Particles fall off and ions separate from the radioactive crud coating and pass in this manner into the water. In this case the particles and ions are transported together with the reactor water to parts which are outside the reactor core, in which case they carry radioactive material to these parts. The radioactive particles and the ions are then deposited as secondarily deposited crud coating on surfaces outside the core. Consequently a radioactive crud coating is also formed outside the core. This radioactive crud coating and the radioactive substances originating from numerous sources lead to a water which is heavily polluted with radioactivity. This leads to the fact that the personnel are exposed to radioactive radiation during servicing and repair work.

In the medium to be treated according to the invention, therefore, a multiplicity of various radioactive particles and ions are present. These radioactive substances termed hereinafter radionuclides can be present in colloidal form, as dissolved anions or cations, or in elemental form.

Radionuclides for the purposes of the present invention is a collective term for all nuclides which differ from stable nuclides by radioactivity and which convert into stable nuclides by possibly a plurality of radioactive transformations. They can of course be of natural origin (for example ⁴⁰K or the members of the 3 large decay series) or can be produced artificially by nuclear reactions (for example transuranics).

However, the mixed beds which are used to date in nuclear power plants are unable by far to remove the radioactive substances from the water. Apparently, the basic principle of mixed beds which encompasses a cation exchanger and an anion exchanger which together are intended to remove cations and anions, is not able to remove sufficiently the different radioactive substances which are present.

The basic principle of the mixed beds must therefore be extended by a further measure which leads to an additional reduction of the radioactivity in the water.

The object of the present invention was to remove as rapidly and effectively as possible the radionuclides occurring in the primary circuit of a nuclear plant, preferably a nuclear power plant, in order to prevent or at least significantly reduce the formation of secondary nuclides or their accompanying substances as are described in the above-discussed prior art, for example the crud or various colloids, from the outset, and to provide per unit time a sufficiently large amount of purified water.

The solution of this object and therefore subject matter of the present invention is a process for the adsorption of radionuclides from media, preferably from waters or aqueous solutions of nuclear plants, preferably nuclear power plants, nuclear enrichment plants, nuclear reprocessing plants or else medical facilities, by contacting the water to be treated or the aqueous solutions with a mixed bed of a heterodisperse or monodisperse gel-type anion exchanger of type I and a heterodisperse or monodisperse gel-type cation exchanger, and also at least one covering layer arranged thereabove of a monodisperse macroporous ion exchanger having a median bead diameter smaller than the ion exchanger used in the mixed bed.

Surprisingly, the combination of a mixed bed with at least one covering layer arranged thereabove of a monodisperse macroporous ion exchanger having a median bead diameter smaller than the ion exchanger used in the mixed bed enables the adsorption of radionuclides as arise in nuclear fission so effectively that the servicing intervals in nuclear power plants can be extended. Furthermore, it has been found that monodisperse, macroporous ion exchangers in combination with a mixed bed are exhausted significantly less rapidly because of secondary effects such as crud deposition or deposition of colloids, as a result of which the efficacy of these ion exchangers is retained over significantly longer times which in turn has a beneficial effect on the servicing intervals of nuclear plants, in particular in nuclear power plants.

The combination according to the invention of a mixed bed and at least one covering layer to be arranged thereabove having a monodisperse macroporous ion exchanger having a median bead diameter smaller than the ion exchanger used in the mixed bed can be used for this purpose, beyond nuclear plants, in all sectors where radionuclides occur in media, preferably in aqueous solutions.

Preferably, they can be used in the decay of radioactive raw materials, for example for cleaning effluents of bismuth or uranium extraction, for cleaning waters in nuclear power plants, reprocessing plants, nuclear enrichment plants or medical facilities, particularly preferably for cleaning waters in what are termed fuel cooling ponds or waters or what are termed “heavy waters” in primary circuits of nuclear power plants or their cleaning circuits.

Above the mixed bed there is applied according to the invention at least one covering layer having a monodisperse, macroporous ion exchanger having a median bead diameter smaller than that of the beads to be used in the mixed bed, preferably two covering layers were applied, particularly preferably one covering layer, wherein the ion exchanger to be used in this case is preferably a chelate resin or an anion exchanger, particularly preferably a strongly basic anion exchanger, a medium-basic anion exchanger, a weakly basic anion exchanger, or a chelate resin. According to the invention, these monodisperse, macroporous ion exchangers to be used in the covering layer have a median bead diameter which is smaller than the bead diameter of the ion exchangers to be used in the mixed bed. The median particle size of the monodisperse ion exchangers to be used in the covering layer is generally 250 to 450 μm, preferably 330 to 400 μm.

A plant which is operating under economic conditions and filled with ion exchangers for effective and rapid removal of radioactive substances must be able to purify a sufficient amount of water per unit time.

Per hour, 10-50 bed volumes, preferably 20-30 bed volumes, of radioactive water are filtered through the mixed beds which are customarily installed in the primary circuit of a nuclear plant.

In the context of the work for the present invention, it has been found that the use of exclusively monodisperse ion exchanger beads in the mixed bed and in the covering layer having bead diameters in the range 200-450 μm is impossible, since then the pressure drop in the column is so great and the water flow rate is so restricted that the required amount of purified water can no longer be produced.

Therefore, according to the invention, the monodisperse ion exchangers of the covering layer and the monodisperse or heterodisperse ion exchangers of the mixed bed must not have too small a median bead diameter. The smaller the median diameter of the beads is, the greater is the resistance opposed to the water flowing through the column. The pressure drop of the liquid increases with decreasing median bead diameter (see http://www.chemgapedia.de/vsengine/supplement/vsc/de/ch/10/heterogene_reaktoren/reaktoren/wirbelschicht_reaktoren/wirbelpunkt/wirbelpunkt.vscml/Fragment/baf0b0cdfc81163f23bf0efc6d863d3d-a1.html and Perry's Chemical Engineers Handbook, Robert H. Perry, Don W. Green, 7th edition, 1997, McGraw Hill, chapter 6, pages 38-40).

In addition, the total surface area of the beads increases with decreasing bead diameter in an identical bed volume.

The median particle size of the monodisperse gel-type ion exchangers in the mixed bed preferably to be used according to the invention is generally 450 to 1250 μm, preferably 500 to 850 μm, particularly preferably 550 to 700 μm.

On account of the knowledge which has been collected in the context of the present work for this invention, a particle size ratio of the ion exchangers between covering layer and mixed bed is sought in the ratio 1-2.2:1.01-3, preferably 1-2.25:1.5-2.95, or used in a device according to the invention.

The mixed beds to be installed in nuclear plants according to the invention are preferably treated in the outflow with the radioactive water to be purified. After loading is terminated, the ion exchangers of the mixed bed are removed and stored in landfills provided especially for this.

The production of monodisperse ion exchangers is known in principle to those skilled in the art. A distinction is made in addition to the fractionation of heterodisperse ion exchangers by sieving between essentially two direct production processes, that is to say jetting, and the seed-feed process in the production of the precursors, the monodisperse polymer beads. In the case of the seed-feed process, a monodisperse feed is used which itself can be generated, for example, by sieving or by jetting. According to the invention, monodisperse ion exchangers produced by the jetting process are preferred for use in the covering layer. However, this also applies to monodisperse, gel-type cation exchangers or anion exchangers to be used in the mixed bed.

In contrast to the heterodisperse particle size distribution known from the prior art, in the present application particle size distributions are termed monodisperse in which at least 75% by volume, preferably at least 85% by volume, particularly preferably at least 90% by volume, of the particles have a diameter which is in the interval about the median diameter having the width of +/−10% of the median diameter.

For example, in the case of polymer beads having median diameter of 0.5 mm, at least 75% by volume, preferably at least 85% by volume, particularly preferably at least 90% by volume, are in a size interval between 0.45 mm and 0.55 mm, in the case of a substance having a median diameter of 0.7 mm, at least 75% by volume, preferably at least 85% by volume, particularly preferably at least 90% by volume, are in a size interval between 0.77 mm and 0.63 mm.

The monodisperse polymer beads, the precursor of the ion exchanger, can be produced, for example, by reacting monodisperse, if appropriate encapsulated, monomer droplets comprising a monovinylaromatic compound, a polyvinylaromatic compound and also an initiator or initiator mixture, and if appropriate a porogen, in aqueous suspension. In order to obtain macroporous polymer beads for producing macroporous ion exchangers, the presence of porogen is absolutely necessary. In a preferred embodiment of the present invention, for synthesis of monodisperse macroporous polymer beads, use is made of microencapsulated monomer droplets. The various processes for producing monodisperse polymer beads not only by the jetting principle but also by the seed-feed principle are known to those skilled in the art from the prior art. At this point, reference is made to U.S. Pat. No. 4,444,961, EP-A 0 046 535, U.S. Pat. No. 4,419,245 and WO 93/12167.

The macroporous property is already given to the anion or chelate exchanger to be used in the covering layer during the synthesis of precursors thereof, the polymer beads. The addition of what is termed porogen here is therefore absolutely necessary. The association of ion exchangers and their macroporous structure is described in DBP 1045102 (1957); DBP 1113570 (1957). Suitable porogens for producing the polymer beads according to the invention are, especially, organic substances which dissolve in the monomer, but dissolve or swell the polymer poorly. Preferably, use is made of aliphatic hydrocarbons, particularly preferably octane, isooctane, decane, isododecane and also alcohols having 4 to 10 carbon atoms, in particular butanol, hexanol or octanol. The anion or chelate exchangers to be used in the covering layer always according to the invention have a macroporous structure. The expression “macroporous” is known to those skilled in the art. Details are described, for example in J. R. Millar et al J. Chem. Soc. 1963, 218. The macroporous ion exchangers of the covering layer to be used according to the invention have a pore volume determined by mercury porosimetry of 0.1 to 2.2 ml/g, preferably 0.4 to 1.8 ml/g.

Functionalizing the polymer beads which are obtainable according to the prior art to give monodisperse, macroporous chelate resins for the covering layer is likewise substantially known to those skilled in the art from the prior art. For instance, EP-A 1 078 690 describes, for example, a process for production of monodisperse ion exchangers having chelating functional groups by the phthalimide process, by
a) reacting monomer droplets of at least one monovinylaromatic compound and at least one polyvinylaromatic compound and also a porogen, and an initiator or an initiator combination, to give monodisperse crosslinked polymer beads,
b) amidomethylating these monodisperse crosslinked polymer beads with phthalimide derivatives,
c) reacting the amidomethylated polymer beads to give aminomethylated polymer beads and
d) reacting the aminomethylated polymer beads with chelating groups to give ion exchangers.

The monodisperse, macroporous chelate exchangers produced according to EP-A 1 078 690 carry the chelating groups forming during process step d)

—(CH₂)ₙ—NR₁R₂

where
R₁ is hydrogen or a radical CH₂—COOH or CH₂P(O)(OH)₂
R₂ is a radical CH₂OOH or CH₂P(O)(OH)₂ and
n is an integer between 1 and 4.

In the further course of this application, such chelate resins are designated resins having iminodiacetic acid groups or having aminomethylphosphonic acid groups.

Alternatively, monodisperse, macroporous chelate resins for the purpose of use in the covering layer can also be produced by the chloromethylation process according to U.S. Pat. No. 4,444,961. In this process, haloalkylated polymers are aminated and the aminated polymer is reacted with chloroacetic acid to form chelate resins of the iminodiacetic acid type. This produces likewise in this manner monodisperse, macroporous chelate resins having iminodiacetic acid groups. Chelate resins having iminodiacetic acid groups can also be obtained by reaction of chloromethylated polymer beads with iminodiacetic acid.

In addition, the chelate exchanger to be used in the covering layer can also alternatively have thiourea groups. The synthesis of monodisperse, macroporous chelate exchangers having thiourea groups is known to those skilled in the art from U.S. Pat. No. 6,329,435, in which aminomethylated monodisperse polymer beads are reacted with thiourea. Monodisperse chelate exchangers having thiourea groups can also be obtained by reacting chloromethylated monodisperse polymer beads with thiourea.

Monodisperse, macroporous chelate exchangers having SH groups (mercapto groups), in the context of the present invention, are likewise suitable for the adsorption of radionuclides in the covering layer. These resins may be synthesized in a simple manner by hydrolysis of the last-mentioned chelate exchangers having thiourea groups.

However, monodisperse, macroporous chelate exchangers having additional acid groups can also be used according to the invention for the adsorption of radionuclides in the covering layer over a mixed bed. WO 2005/049190 describes the synthesis of monodisperse chelate resins which comprise not only carboxyl groups but also —(CH₂)ₘNR₁R₂ groups, by reacting monomer droplets of a mixture of a monovinylaromatic compound, a polyvinylaromatic compound, a (meth)acrylic compound, an initiator or an initiator combination, and also if appropriate a porogen, to give crosslinked polymer beads, functionalizing the resultant polymer beads with chelating groups, and in this step reacting the copolymerized (meth)acrylic compounds to give (meth)acrylic acid groups, wherein
m is an integer from 1 to 4,
R₁ is hydrogen or a CH₂—COOR₃ radical or CH₂P(O)(OR₃)₂ or —CH₂—S—CH₂COOR₃ or —CH₂—S—C₁—C₄ alkyl or
—CH₂—S—CH₂CH(NH₂)COOR₃ or

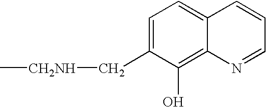

or its derivatives or C═S(NH₂),
R₂ is a CH₂COOR₃ radical or CH₂P(O)(OR₃)₂ or —CH₂—S—CH₂COOR₃ or —CH₂—S—C₁C₄ alkyl or —CH₂—S—CH₂CH(NH₂)COOR₃ or

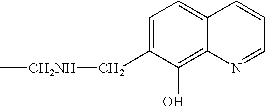

or its derivatives or C═S(NH₂) and
R₃ is H or Na or K.

Monodisperse, macroporous chelate resins having picolylamino groups which are known from DE-A 10 2006 00 49 53 can also be used for the adsorption of radionuclides in a covering layer over a mixed bed. These are obtainable by
a) producing monodisperse, macroporous polymer beads based on styrene, divinylbenzene and ethylstyrene according to the above-described prior art either by jetting or by a seed-feed process,
b) amidomethylating these monodisperse macroporous polymer beads,
c) converting the function of the amidomethylated polymer beads in the alkaline medium to aminomethylated polymer beads and
d) functionalization with picolyl chloride hydrochloride to give the desired monodisperse chelate exchanger having picolylamino groups.

The production of monodisperse, macroporous, strongly basic anion exchangers is likewise known to those skilled in the art. These anion exchangers can be produced by amidomethylation of crosslinked monodisperse macroporous styrene polymers and subsequent quaternization of the resultant aminomethylate. A further synthesis pathway for monodisperse, macroporous, strongly basic anion exchangers is chloromethylation of said polymer beads with subsequent amination, for example using trimethylamine or dimethylaminoethanol. Monodisperse, macroporous, strongly basic anion exchangers which are preferred according to the invention can be obtained by the process described in EP-A 1 078 688.

Monodisperse, macroporous, weakly basic anion exchangers may be obtained by alkylating the above-described aminomethylate. By partial alkylation, the monodisperse, macroporous, weakly basic anion exchangers can be converted into monodisperse, macroporous, medium-basic anion exchangers. The production of these anion exchanger types is likewise described in EP-A 1 078 688.

Monodisperse, macroporous, weakly basic or strongly basic anion exchangers of the acrylate type are likewise suitable for the use according to the invention in the covering layer over a mixed bed. Their production can proceed, for example, according to EP-A 1 323 473.

The monodisperse polymer beads can also be converted to anion exchange beads using processes known in the specialist field for conversion of crosslinked addition polymers of mono- and polyethylenically unsaturated monomers. In the production of weakly basic resins from poly(vinylaromatic) copolymer beads, such as crosslinked polystyrene beads, the beads are advantageously haloalkylated, preferably halomethylated, optimally chloromethylated, and the ion-active exchange groups are subsequently added to the haloalkylated copolymer. The processes for haloalkylation of crosslinked addition copolymers and the haloalkylating agents which participated in these processes are known in the art to which reference is made for the purposes of this invention: U.S. Pat. No. 4,444,961 and “Ion Exchange” by F. Helfferich, published 1962 by the McGraw-Hill Book Company, N.Y. Usually, the haloalkylation reaction comprises swelling the crosslinked addition copolymer with a haloalkylating agent, preferably bromomethyl methyl ether, chloromethyl methyl ether or a mixture of formaldehyde and hydrochloric acid, optimally chloromethyl methyl ether, and the subsequent reaction of the copolymer and the haloalkylating agent in the presence of a Friedel-Crafts catalyst, such as zinc chloride, iron chloride and aluminum chloride.

Generally, the monodisperse, macroporous ion exchangers of haloalkylated beads are produced by contacting these beads with a compound which reacts with the halogen of the haloalkyl group and which in the reaction forms an active ion exchange group. Such methods and compounds to obtain therefrom ion exchange resins, i.e. weakly basic resins and strongly basic monodisperse, macroporous anion exchangers, are known from U.S. Pat. No. 4,444,961. Usually, a weakly basic monodisperse, macroporous anion exchange resin is produced by contacting the haloalkylated copolymer with ammonia, a primary amine or a secondary amine. Representative primary or secondary amines include methylamine, ethylamine, butylamine, cyclohexylamine, dimethylamine, diethylamine and the like. Strongly basic monodisperse, macroporous ion exchange resins were produced by using tertiary amines, such as trimethylamine, triethylamine, tributylamine, dimethylisopropanolamine, ethylmethylpropylamine or similar aminating agents.

Amination generally includes heating a mixture of the haloalkylated copolymer beads and at least a stoichiometric amount of the aminating agent, i.e. ammonia or amine, under reflux to a temperature which is sufficient to react the aminating agent with the halogen atom which is located on the carbon atom in the alpha position to the aromatic nucleus of the polymer. It is advantageous when, if appropriate, a swelling agent such as water, ethanol, methanol, methylene chloride, ethylene dichloride, dimethoxymethylene or combinations thereof is used. Usually, the amination is carried out under conditions such that the anion exchange sites are uniformly distributed in the entire bead. A substantially complete amination is generally obtained within about 2 to about 24 hours at a reaction temperature between 25 and about 150° C.

Further methods for adding other types of anion exchange groups, such as phosphonium groups, to copolymer beads are described in U.S. Pat. No. 5,449,462.

Since the amount of crosslinker, preferably divinylbenzene, which is used in the production of the beads having a core and sheath structure changes as a function of the structure radius owing to the processes used for producing the beads, a process for expressing the degree of crosslinking which reflects this fact is used. In the case of the non-functionalized copolymer beads, a toluene swelling test can be used for determining the “effective” crosslinking density, as is stated, for example, in example 1 of U.S. RE Pat. No. 34.112.

Because the monodisperse, macroporous ion exchangers to be used in the covering layer are extraordinarily tough and fracture resistant, the generation of “fines fractions” is kept to a minimum, which further improves performance and service life of the covering layer and therefore of the entire unit of mixed bed and covering layer. Standard processes for sieving the resins, in order to remove all fines fractions generated during transport and handling of the resins, can of course be used when filling the plant for the first time, in order to maximize the performance of the combination of mixed bed and covering layer according to the invention.

The mixed bed itself contains monodisperse or heterodisperse, gel-type anion exchangers of type I and heterodisperse or monodisperse gel-type cation exchangers. Preferably, in the mixed bed, again use is made of monodisperse, gel-type anion exchangers of type I and monodisperse, gel-type cation exchangers. The gel-type property is obtained by omitting porogen in the processes which are already described above with respect to the covering layer for producing anion exchangers. The designation type I resin generally designates strongly basic anion exchangers having quaternary trimethylammonium groups (Ullmanns Encyclopädie der technischen Chemie [Ullmann's Encyclopedia of Industrial Chemistry], 4th edition, volume 13, page 302). Its production proceeds as described above, for example according to the methods of EP-A 10 78 688. The gel-type anion exchangers to be used in the mixed bed preferably have a degree of crosslinking of 4 to 10, particularly preferably 5 to 7. Degree of crosslinking is taken to mean the fraction of crosslinker to be used in the synthesis, preferably divinylbenzene, in relation to the polymer base, preferably styrene. According to the invention a material which is suitable in particular for the mixed bed is the gel-type anion exchanger Lewatit® MonoPlus M 800 KR marketed by Lanxess Deutschland GmbH.

The gel-type cation exchangers to be used according to the invention in the mixed bed are likewise obtained by known methods with omission of the use of porogen.

The production of heterodisperse gel-type, strongly acidic cation exchangers is described, for example, in R. Kunin, Ion Exchange Resins, Robert E. Krieger, Publishing Company, Huntington, 1972, page 73 ff. and in U.S. Pat. No. 6,646,017.

The production of monodisperse, gel-type strongly acidic cation exchangers is described in EP-A 0 046 535 and in EP-A 1 222 960.

The gel-type cation exchangers to be used in the mixed bed preferably have a degree of crosslinking of 6 to 16, particularly preferably 8 to 12. Degree of crosslinking is taken to mean the fraction of crosslinker, preferably divinylbenzene, to be used in the synthesis, in relation to the polymer base, preferably styrene. According to the invention, a material which is suitable in particular for the mixed bed is the gel-type cation exchanger Lewatit® S 200 KR marketed by Lanxess Deutschland GmbH.

With the combination of at least one covering layer of a monodisperse, macroporous anion exchanger or chelate resin having a median bead diameter smaller than that of the beads to be used in the mixed bed and a mixed bed of a gel-type anion exchanger and a gel-type cation exchanger it is possible to adsorb radionuclides, particularly as arise in nuclear plants, effectively from their media, preferably their aqueous solutions.

Radionuclides is a collective term for all nuclides which differ from stable nuclides by radioactivity and which convert into stable nuclides by possibly a plurality of radioactive transformations. They can be of natural origin (for example ⁴⁰K or the members of the 3 large decay series) or can be produced artificially by nuclear reactions (for example transuranics).

Important natural radionuclides are, for example, ²¹⁰Po, ²²⁰Rn, ²²⁶Ra, ²³⁵U, ²³⁸U. They decay with α- or β-emission; as an accompanying phenomenon, frequently (for example in the case of ²²⁶Ra), γ quanta are emitted, the energy of which is likewise a plurality of MeV or keV. The artificially generated radionuclides, as arise, for example, in nuclear plants, are of considerably more importance for use of the monodisperse macroporous ion exchangers. Radionuclides which are not very short-lived occur in the nuclear fission of uranium in reactors, when used fuel elements are processed, for example by the Purex process. The most important fission products include ⁸⁵Kr, ¹³⁷Cs, ⁹⁹Sr, ⁹⁰Sr, ¹⁴⁰Ba, ⁹⁵Zr, ⁹⁹Mo, ¹⁰⁶Ru, ¹⁴⁴Ce, ¹⁴⁷Nd, which themselves are in turn mother nuclides of further daughter products resulting mostly by beta decay.

As a result of the nuclear reaction, further radionuclides (from ambient nuclides) are formed in the nuclear reactor, such as ³¹P, ³²P, ⁵⁸Co, ⁶⁰Co, ⁵⁴Mn, ⁶⁵Zn, ¹⁸⁷W, ¹²²Sb, ¹²⁴Sb, ¹²⁵Sb, ¹¹⁰Ag, ¹⁹⁷Au or ¹⁹⁸Au.

All said radionuclides may be isolated by the device according to the invention from media, preferably their solutions, from waters or their aqueous solutions.

In addition, however, short-lived radionuclides such as are used in particular in medicine can also be absorbed using the device according to the invention, preferably ¹³¹In, ^{99m}Tc, ⁶⁴Cu, ¹⁹⁷Hg, ¹⁹⁸Au, ¹³¹I to ¹⁴²I, ⁵⁹Fe.

The present invention therefore also relates to the use of the combination of a mixed bed having a covering layer of monodisperse, macroporous ion exchanger having a median bead diameter smaller than that of the beads to be used in the mixed bed for adsorption of radionuclides from their solutions, preferably waters or their aqueous solutions, preferably of ²¹⁰Po, ²²⁰Ru, ²²⁶Ra, ²³²Th, ²³⁵U, ²³⁸U, ⁸⁵Kr, ¹³⁷Cs, ⁸⁹Sr, ⁹⁰Sr, ¹⁴⁰Ba, ⁹⁵⁷X, ⁹⁹Mo, ¹⁰⁶Ru, ¹⁴⁴Ce, ¹⁴⁷Nd, ³¹P, ³²P, ⁵⁸Co, ⁶¹CO, ¹⁹⁷Au, ¹⁹⁸Au, ¹¹⁰Ag ¹³¹In, ⁹⁹Tc, ⁶⁴Cu, ⁵⁴Mn, ⁶⁵Zn, ¹⁸⁷W, ¹²²Sb, ¹²⁴Sb, ¹²⁵Sb, ¹⁹⁷Hg, ¹³¹I to ¹⁴²I, ⁵⁹Fe, ⁴⁰K, ²⁴Na.

The larger the diameter of the monodisperse, macroporous ion exchangers in the covering layer, the smaller is the number of monodisperse beads in total per m³ of ion exchanger within the covering layer. The smaller the beads are, the more beads are present in one m³ of ion exchanger. This is linked to the fact that the total surface area of all beads which are present in one m³ of ion exchanger increases with decreasing bead diameter. This also applies to the use of monodisperse, gel-type anion exchangers or cation exchangers in the mixed bed.

In the context of the present invention it has been found that for the adsorption of radionuclides from liquids, it is beneficial when the total surface area of all beads via which the adsorption proceeds is as large as possible. This applies in particular to the covering layer and is best ensured using monodisperse, macroporous ion exchangers of small bead diameter, since as a result of the monodispersity, the diffusion pathways of the radionuclides into the beads were equally long and in addition as a result of beads of small diameter the total surface area is increased. The macroporosity of the ion exchanger in the covering layer according to the invention promotes the adsorption of radionuclides.

In the context of the present invention it has been found that the industrially and economically expedient reduction of the median diameter of monodisperse ion exchangers to obtain a bead surface area as high as possible is limited by the fact that the pressure drop of the liquid stream on flowing through the columns packed with beads of monodisperse ion exchangers markedly increases with decreasing median bead diameter.

If monodisperse ion exchange beads are present in the mixed bed having a median bead diameter of approximately 100 μm, in the context of the work for the present invention it has been found that the pressure drop which occurs when liquid is filtered through can already be so high that, per unit time, only a subquantity of the radioactive water which arises can be purified.

A plant according to the invention operating under economic conditions and filled with ion exchangers for working up radioactive waters must be able to purify a sufficient amount of water per unit time. According to the invention, this problem is solved by the covering layer with monodisperse ion exchangers having a median bead diameter smaller than that of the beads of the mixed bed, wherein the median bead diameter should be sufficiently large that the flowthrough of radioactive water is only moderately impeded—low pressure drop.

When a “breakthrough” occurs, the ion exchangers in the mixed bed can usually be reactivated a multiplicity of times by stirring the bed. Because of the sensitive site of use, the ion exchange bed is usually not regenerated in the same sense as usual ion exchangers, that is to say by using strong acids and bases. Instead, the exhausted resin together with the collected radionuclides and any additional radioactive substances is usually solidified, collected and disposed of like other low-level radioactive waste from nuclear power plant reactors.

The liquids which exit from the device according to the invention of mixed bed and covering layer and are depleted in radionuclides can be monitored using standard appliances such as measuring instruments for weak scintillation and radionuclide-specific analytic methods in order to observe when a breakthrough occurs, so that at this timepoint the required steps can be taken for reactivating the mixed bed or collecting and disposing of the used resin.

However, the present application also relates to a device for the adsorption of radionuclides from media, preferably waters or aqueous solutions as arise, for example, in nuclear plants, preferably nuclear power plants, by contacting the medium to be treated, preferably water or aqueous solutions, with a mixed bed which is additionally provided with at least one covering layer of a monodisperse, macroporous ion exchanger having a median bead diameter smaller than the ion exchanger used in the mixed bed.

### BRIEF DESCRIPTION OF THE DRAWINGS

FIG. 1 schematically illustrates a device according to the prior art is shown, in which a is the feed to the mixed bed and b is the outlet from the mixed bed. M is mixed bed.

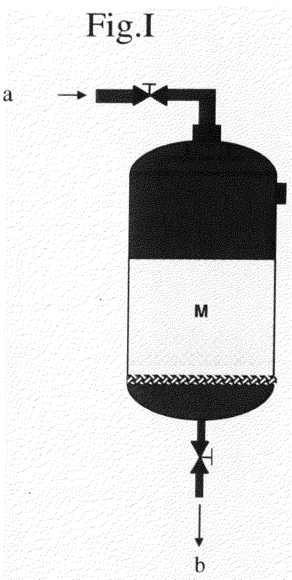

FIG. 2 schematically illustrates a device according to the invention is shown, in which a, b and M have the same meanings given above and C is a covering layer of a monodisperse, macroporous ion exchanger having a median bead diameter smaller than the ion exchanger used in the mixed bed.

FIG. 3 schematically illustrates a device according to the invention having two covering layers C and D over the mixed bed M is shown, and a and b have the same meanings as described above. The monodisperse, macroporous ion exchangers used in the covering layers C and D also each have a median bead diameter smaller than the ion exchangers used in the mixed bed.

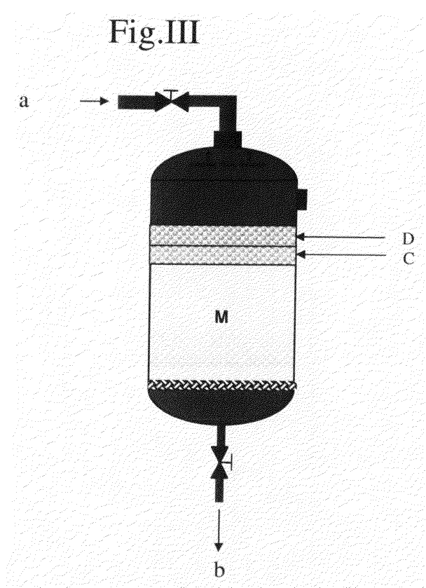

### METHODS OF ANALYSIS

Number of Perfect Beads after Production

100 beads are viewed under the microscope. The number of beads which carry cracks or fragmentation is determined. The number of perfect beads results from the difference between the number of damaged beads and 100.

### Usable Capacity of Strongly Basic Anion Exchangers

1000 ml of anion exchanger in the chloride form, i.e. the nitrogen atom bears chloride as counterion, are charged into a glass column. 2500 ml of 4% strength by weight sodium hydroxide solution are filtered through the resin in 1 hour. The column is then washed with 2 liters of debased, i.e. decationized, water. Then, water having a total anion hardness of 25 degrees of German hardness is filtered through the resin at a rate of 10 liters per hour. In the eluate, the hardness and also the residual amount of silicic acid are analyzed. At a residual silicic acid content of ≧0.1 mg/l, loading is ended.

From the amount of water which is filtered through the resin, the total anion hardness of the water filtered through and also the amount of resin installed, the number of grams of CaO which are absorbed per liter of resin is determined. The gram rate of CaO is the usable capacity of the resin in the units gram of CaO per liter of anion exchanger.

### Determination of the Amount of Basic Aminomethyl Groups in the Aminomethylated, Crosslinked Polystyrene Polymer Beads

100 ml of the aminomethylated polymer beads are vibrated on the tamping volumeter, and subsequently flushed by demineralized water into a glass column. In 1 hour and 40 minutes, 1000 ml of 2% strength by weight sodium hydroxide solution are filtered through. Subsequently, demineralized water is filtered until 100 ml of eluate admixed with phenolphthalein have a consumption of 0.1N (0.1 normal) hydrochloric acid of at most 0.05 ml.

50 ml of this resin are admixed in a glass beaker with 50 ml of demineralized water and 100 ml of 1N hydrochloric acid. The suspension is stirred for 30 minutes and subsequently charged into a glass column. The liquid is drained off. A further 100 ml of 1N hydrochloric acid are filtered through the resin in 20 minutes. Subsequently, 200 ml of methanol are filtered through. All eluates are collected and combined and titrated with methyl orange with 1N sodium hydroxide solution.

The amount of aminomethyl groups in 1 liter of aminomethylated resin is calculated using the following formula: (200−V)·20=mol of aminomethyl groups per liter of resin.

### Determination of the Amount of Weakly and Strongly Basic Groups in Anion Exchangers

100 ml of anion exchanger is charged with 1000 ml of 2% strength by weight sodium hydroxide solution in a column in 1 hour and 40 minutes. The resin is then washed with demineralized water for removing the excess sodium hydroxide solution.

### Determination of the NaCl Number

50 ml of the exchanger in the free base form and washed to neutrality are placed in a column and charged with 950 ml of 2.5% strength by weight sodium chloride solution. The effluent is collected, made up to 1 liter with demineralized water and 50 ml thereof are washed with 0.1N (=0.1 normal hydrochloric acid) hydrochloric acid.

ml of 0.1N hydrochloric acid consumed× 4/100=NaCl number in mol/l of resin.

### Determination of the NaNO₃ Number

Then, 950 ml of 2.5% strength by weight sodium nitrate solution are filtered through. The effluent is made up to 1000 ml with demineralized water. An aliquot thereof, 10 ml, is taken off and analyzed for its chloride content by titration with mercury nitrate solution.

ml of Hg(NO₃) solution consumed×factor/17.75=NaNO₃ number in mol/l of resin.

### Determination of the HCl Number

The resin is washed with demineralized water and flushed into a glass beaker. It is admixed with 100 ml of 1N hydrochloric acid and allowed to stand for 30 minutes. The entire suspension is flushed into a glass column. A further 100 ml of hydrochloric acid are filtered through the resin. The resin is washed with methanol. The effluent is made up to 1000 ml with demineralized water. Approximately 50 ml thereof are titrated with 1N sodium hydroxide solution.

(20−ml of 1N sodium hydroxide solution consumed)/5=HCl number in mol/l of resin.

The amount of strongly basic groups is equal to the sum of NaNO₃ number and HCl number.

The amount of weakly basic groups is equal to the HCl number.

### Uniformity Coefficient

Quotient of the bead sizes at which 60 and 10 percent by mass fall through a sieve.

### Median Bead Diameter

Bead diameter at which 50% of the beads are greater and smaller.

### Determination of the Amount of Chelating Groups—Total Capacity (Tc) of the Resin

100 ml of exchanger are charged into a filter column and eluted with 3% strength by weight hydrochloric acid in 1.5 hours. The column is then washed with demineralized water until the effluent is neutral.

50 ml of regenerated ion exchanger are charged in a column with 0.1N sodium hydroxide solution (=0.1 normal sodium hydroxide solution). The effluent is collected each time in a 250 ml measuring flask and the total amount is titrated with 1N hydrochloric acid against methyl orange.

Application is continued until 250 ml of effluent have a consumption of 24.5-25 ml of 1N hydrochloric acid. After the test is ended the volume of exchanger in the Na form is determined.

Total capacity (TC)=(X·25−ΣV)·2·10⁻² in mol/l of exchanger.

X=number of effluent fractions

ΣV=total consumption in ml of 1N hydrochloric acid in the titration of the effluents.

### EXAMPLES

### Example 1

### Production of a Macroporous, Monodisperse Chelate Resin Having Iminodiacetic Acid Groups Having a Median Bead Diameter of 345 μm

### 1a) Production of the Monodisperse, Macroporous Polymer Beads Based on Styrene, Divinylbenzene and Ethylstyrene

3000 g of demineralized water were charged into a 10 l glass reactor and a solution of 10 g of gelatin, 16 g of disodium hydrogenphosphate dodecahydrate and 0.73 g of resorcinol in 320 g of deionized water was added and mixed. The mixture was heated to 25° C. With stirring, subsequently, a mixture of 3200 g of microencapsulated monomer droplets having a narrow particle size distribution of 3.6% by weight divinylbenzene and 0.9% by weight ethylstyrene (used as commercially available isomeric mixture of divinylbenzene and ethylstyrene having 80% divinylbenzene), 0.5% by weight dibenzoyl peroxide, 56.2% by weight styrene and 38.8% by weight isododecane (technical isomeric mixture having a high fraction of pentamethylheptane) was added, wherein the microcapsules consisted of a formaldehyde-cured complex coacervate of gelatin and a copolymer of acrylamide and acrylic acid, and 3200 g of aqueous phase having a pH of 12 were added. The median particle size of the monomer droplets was 260 μm.

The batch was polymerized to completion with stirring by temperature elevation according to a temperature program starting at 25° C. and ending at 95° C. The batch was cooled, washed over a 32 μm sieve and subsequently dried in a vacuum at 80° C. This produced 1893 g of a spherical polymer having a median particle size of 250 μm, narrow particle size distribution and smooth surface.

The polymer was chalky white in appearance and had a bulk density of approximately 350 g/l.

### 1b) Production of the Amidomethylated Polymer Beads

At room temperature, 1596 g of dichloroethane, 470 g of phthalimide and 337 g of 29.1% strength by weight formalin were charged. The pH of the suspension was set to 5.5 to 6 using sodium hydroxide solution. The water was then removed by distillation. Then, 34.5 g of sulfuric acid were added. The resultant water was removed by distillation. The batch was cooled. At 30° C., 126 g of 65% strength oleum and subsequently 424 g of monodisperse polymer beads produced in accordance with process step 1a) were added. The suspension was heated to 70° C. and stirred for a further 6 hours at this temperature. The reaction broth was taken off, demineralized water was added and residual amounts of dichloroethane were removed by distillation.

Yield of amidomethylated polymer beads: 1800 ml
Composition by elemental analysis:
Carbon: 78.5% by weight;
Hydrogen: 5.2% by weight;
Nitrogen: 4.8% by weight;
Remainder: oxygen.
1c) Production of the aminomethylated polymer beads

478 g of 50% strength by weight sodium hydroxide solution and 1655 ml of demineralized water were added to 1785 ml of amidomethylated polymer beads at room temperature. The suspension was heated to 180° C. and stirred for 6 hours at this temperature.

The resultant polymer beads were washed with demineralized water.

Yield of aminomethylated polymer beads: 1530 ml
Composition by elemental analysis:
Carbon: 82.9% by weight
Nitrogen: 8.0% by weight
Hydrogen: 8.2% by weight
HCl number: 1.81 mol/l

From the composition by elemental analysis of the aminomethylated polymer beads, it may be calculated that on a statistical average per aromatic nucleus, originating from the styrene and divinylbenzene units, 0.78 hydrogen atoms were substituted by aminomethyl groups.

### 1d) Production of the Ion Exchanger Having Chelating Iminodiacetic Acid Groups

1530 ml of aminomethylated polymer beads from example 1c) were added to 1611 ml of demineralized water at room temperature. The suspension was heated to 90° C. At this temperature, to this suspension there were added in 4 hours 589 g of sodium salt of monochloroacetic acid, wherein the pH was maintained at 9.2 using sodium hydroxide solution. Subsequently, the suspension was heated to 95° C. and stirred for a further 6 hours at this temperature. The pH was set to and maintained at 10.5.

Thereafter the suspension was cooled. The resin was washed with demineralized water.

### Yield: 2700 ml

Total capacity of the resin: 1.92 mol/l of resin
Median bead diameter of the resin: 345 μm
Resin stability: 99% whole beads
Uniformity coefficient: 1.035

The total surface area of all beads which are present in one m³ of chelate resin was 6 521 739 m².

### Example 2

### Production of a Strongly Basic Monodisperse, Macroporous Anion Exchanger Having Trimethylammonium Groups and a Median Bead Diameter of 380 μm

### 2a) Production of the Amidomethylated Polymer Beads

2440 g of dichloroethane, 659 g of phthalimide and 466 g of 29.4% strength by weight formalin were charged at room temperature. The pH of the suspension was set to 5.5 to 6 using sodium hydroxide solution. Subsequently the water was removed by distillation. Then, 48.3 g of sulfuric acid were added. The resultant water was removed via distillation. The batch was cooled. At 30° C., 165 g of 65% strength oleum and subsequently 424 g of monodisperse polymer beads produced by process step 1a) were added. The suspension was heated to 70° C. and stirred for a further 6 hours at this temperature. The reaction broth was taken off, demineralized water was added and residual amounts of dichloroethane were removed by distillation.

Yield of amidomethylated polymer beads: 2200 ml
Composition by elemental analysis:
Carbon: 76.6% by weight;
Hydrogen: 4.9% by weight;
Nitrogen: 5.4% by weight;
Remainder: oxygen.

### 2b) Production of the Aminomethylated Polymer Beads

662 g of 50% strength by weight sodium hydroxide solution and 1313 ml of demineralized water at room temperature were added to 2170 ml of amidomethylated polymer beads. The suspension was heated to 180° C. in the course of 2 hours and stirred at this temperature for 6 hours.

The resultant polymer beads were washed with demineralized water.

Yield of aminomethylated polymer beads: 1760 ml
This gave a total yield, estimated, of 2288 ml.
Composition by elemental analysis:
Nitrogen: 9.6% by weight
Carbon: 78.9% by weight;
Hydrogen: 8.2% by weight;

We calculated from the composition by elemental analysis of the aminomethylated polymer beads that on a statistical average, per aromatic nucleus, originating from the styrene and divinylbenzene units, 1.04 hydrogen atoms were substituted by aminomethyl groups.

Determination of the amount of basic groups: 2.0 mol/liter of resin

### 2c) Production of the Strongly Basic Anion Exchanger

468 ml of 50% strength by weight sodium hydroxide solution and 1720 ml of aminomethylated polymer beads from example 2b) were added to 2891 ml of demineralized water. Subsequently, 636 grams of chloromethane were added.

The batch was heated to 40° C. and stirred at this temperature for 16 hours. After cooling, the resin was first washed with water. The resin was transferred into a column and 3000 ml of 5% strength by weight aqueous sodium chloride solution were filtered through in the course of 30 minutes from the top.

Subsequently the resin was washed with water and classified.

Resin yield: 2930 ml
Median bead diameter: 380 Urn
Uniformity coefficient: 1.035
NaCl number: 0.593 mol/l of resin
NaNO₃ number: 1.03 mol/l of resin
HCl number: 0.005 mol/l of resin
Resin stability: 99% whole beads
Usable capacity: 0.57 mol/l of resin

### Example 3

### Production of a Monodisperse, Macroporous Ion Exchanger Having Chelating Aminomethyl-Phosphonic Acid Groups Having a Median Bead Diameter of 365 μm

226 ml of demineralized water were charged into a reactor. To this were metered 435 ml of aminomethylated polymer beads from example 2b). In the course of 15 minutes, 227.8 grams of dimethyl phosphite were added thereto. Thereafter, the mixture was stirred for a further 30 minutes. The suspension was heated to 60° C. In the course of 4 hours, at 60° C., 735.4 grams of sulfuric acid monohydrate were added thereto. Thereafter, the mixture was heated to reflux temperature. 317.8 grams of 29.27% strength by weight formalin solution were metered thereto. The mixture was stirred for a further 6 hours at reflux temperature.

Thereafter the suspension was cooled. The resin was washed with demineralized water.

Yield in the hydrogen form: 640 ml

The resin was packed into a column. 2000 ml of 4% strength by weight aqueous sodium hydroxide solution were filtered through and thereafter the resin was washed with demineralized water and classified.

Yield in the sodium form: 1031 ml
Composition by elemental analysis:
nitrogen: 4.1% by weight
phosphorus: 16.0% by weight
total capacity: amount of weakly acidic groups 2.83 mol/l
original stability: 97% whole beads

### Example 4

### Production of Monodisperse, Gel-Type Polymer Beads Based on Styrene, Divinylbenzene and Ethylstyrene Having a Divinylbenzene Content of 9.5% by Weight

3000 g of demineralized water were charged into a 11 liter glass reactor and a solution of 10 g of gelatin, 16 g of disodium hydrogenphosphate dodecahydrate and 0.73 g of resorcinol in 320 g of demineralized water was added thereto and mixed. The mixture was heated to 25° C. With stirring, subsequently, a mixture of 3200 g of microencapsulated monomer droplets having a narrow particle size distribution of 9.5% by weight divinylbenzene and 1.9% by weight ethylstyrene (used as commercially available isomeric mixture of divinylbenzene and ethylstyrene having 80% divinylbenzene), 0.6% by weight dibenzoyl peroxide and 88.6% by weight of styrene was added, wherein the microcapsules consisted of a formaldehyde-cured complex coacervate of gelatin and a copolymer of acrylamide and acrylic acid, and 3200 g of aqueous phase having a pH of 12 were added. The median particle size of the monomer droplets was 430 μm.

The batch was polymerized to completion with stirring by temperature elevation according to a temperature program starting at 25° C. and ending at 95° C. The batch was cooled, washed over a 32 μm sieve and subsequently dried in a vacuum at 80° C. This produced 1893 g of a spherical polymer having a median particle size of 425 μm, narrow particle size distribution and smooth surface.

### Example 5

### Production of a Gel-Type, Monodisperse Strongly Acidic Cation Exchanger Having a Median Bead Diameter of 594 μm

490 grams of 78% strength by weight sulfuric acid were charged into a reactor at room temperature.

In the course of 5 minutes, with stirring, 200 grams of monodisperse, gel-type polymer beads from example 4 were metered thereto. Subsequently, the mixture was stirred for a further 5 minutes at room temperature. In 5 minutes, 60 ml of 1,2-dichloroethane were metered thereto. Subsequently, the mixture was heated in 15 minutes to 40° C. and stirred for a further 30 minutes at this temperature. The suspension was heated in one hour to 80° C. During this 427 g of 65% strength by weight oleum were metered thereto in 30 minutes. The suspension was heated to 115° C. in 30 minutes. It was stirred for a further 3 hours at 115° C. The 1,2-dichloroethane liberated was removed from the system by distillation.

In one hour the mixture was heated to 135° C. It was stirred for a further 3 hours at 135° C.

After it was cooled to room temperature, the suspension was flushed into a glass column using 78% strength by weight sulfuric acid and sulfuric acids of decreasing concentration, starting with 78% strength by weight sulfuric acid, were filtered through. Subsequently, the column was washed with demineralized water.

Resin yield: 840 ml
Total capacity in the hydrogen form: 2.20 mol/l of resin
Resin stability: 99% whole beads
Median bead diameter: 594μ

### Example 6

### Production of Monodisperse, Gel-Type Polymer Beads Based on Styrene, Divinylbenzene and Ethylstyrene Having a Divinylbenzene Content of 6.0% by Weight

3000 g of demineralized water were charged into a 10 liter glass reactor and a solution of 10 g of gelatin, 16 g of disodium hydrogenphosphate dodecahydrate and 0.73 g of resorcinol in 320 g of demineralized water was added thereto and mixed. The mixture was heated to 25° C. With stirring, subsequently, a mixture of 3200 g of microencapsulated monomer droplets having a narrow particle size distribution of 6.0% by weight divinylbenzene and 1.1% by weight ethylstyrene (used as commercially available isomeric mixture of divinylbenzene and ethylstyrene having 80% divinylbenzene), 0.6% by weight dibenzoyl peroxide and 92.9% by weight styrene was added thereto, wherein the microcapsules consisted of a formaldehyde-cured complex coacervate of gelatin and a copolymer of acrylamide and acrylic acid, and 3200 g of aqueous phase having a pH of 12 were added. The median particle size of the monomer droplets was 440 μm.

The batch was polymerized to completion with stirring by temperature elevation according to a temperature program starting at 25° C. and ending at 95° C. The batch was cooled, washed over a 32 μm sieve and subsequently dried in a vacuum at 80° C. This produced 1893 g of a spherical polymer having a median particle size of 430 μm, narrow particle size distribution and smooth surface.

### Example 7

### Production of a Gel-Type, Monodisperse Anion Exchanger Having Strongly Basic Trimethylammonium Groups Having a Median Bead Diameter of 610 μm

### 7a) Chloromethylation of the Monodisperse, Gel-Type Polymer Beads of Example 6

1120 ml of a mixture of monochlorodimethyl ether, methylal and iron(III) chloride (14.8 g/l) were charged into a 2 liter sulfonation flask and subsequently 240 g of polymer beads from example 6 were added. The mixture was heated to 50° C. and stirred for 6 h under reflux in the range of 50-55° C. During the reaction time, hydrochloric acid and low-boiling organics were expelled or distilled off. Subsequently the reaction suspension was successively intensively washed with 1200 ml of methanol, 2400 ml of methylal, 3 times with 1200 ml of methanol and finally with demineralized water. This produced 590 ml of water-wet, monodisperse, gel-type chloromethylated polymer beads having a chlorine content of 20.1% by weight.

7b) Reaction of the Gel-Type, Monodisperse, Chloromethylated Polymer Beads from Example 7a) to Give a Monodisperse, Strongly Basic Anion Exchanger Having Trimethylammonium Groups and a Median Bead Diameter of 610 μm

779 ml of methanol were charged into the autoclave. To this were added 500 ml of vacuum filter-wet chloromethylated polymer beads from example 7a) and 330 grams of 45% strength by weight aqueous trimethylammonium solution.

The suspension was heated to 120° C. and stirred for a further 3 hours at this temperature. After it was cooled to room temperature, the mother liquor was removed by suction, the resin was admixed with 800 ml of demineralized water and stirred for 30 minutes at room temperature. The water was distilled off and replaced by 2000 ml of 3% strength by weight aqueous hydrochloric acid. The suspension was stirred for 4 hours at 50° C. After it was cooled, the liquid phase was distilled off, the resin taken up with water and eluted in a column from the bottom using 6 bed volumes of water.

### Yield: 1360 ml

Number of perfect beads: 98%
Median bead diameter: 610 μm
Total capacity:
NaNO₃ number: 1.23 mol/l
NaCl number: 0.56 mol/l
HCl number: 0.03 mol/l

Demineralized water, for the purposes of the present invention, is characterized by having a conductivity of 0.1 to 10 μS, wherein the content of dissolved or undissolved metal ions is not greater than 1 ppm, preferably not greater than 0.5 ppm, for Fe, Co, Ni, Mo, Cr, Cu as individual components and not greater than 10 ppm, preferably not greater than 1 ppm, for the sum of said metals.

### Example 8

### Radiochemical Laboratory Test

For determination of the decontamination factors, 7×1 liter oxygen-saturated samples were taken off from the primary circuit of a nuclear power plant using a sampling box. 1 liter of untreated sample served as initial measurement for the calculation of the decontamination factors. Then, in each case 2 liters from the primary circuit ran at a flow rate of 2 liters/h through a device according to the invention containing the combination of a mixed bed of 200 ml of Lewatit® S200KR and Lewatit® M800 KR and also a covering layer of 100 ml of Lewatit® TP 207 MDS OH. The entire column measured 800 mm in height and 40 mm in diameter, in which the mixed bed occupied 300 mm and the covering layer 75 mm. The resin layer was saturated with boric acid or LiOH solution. The experiments are repeated on two successive days, wherein the loading water (7 liters of oxygen-saturated water) had been taken off from the primary circuit of a nuclear power plant. 1 liter served as initial measurement: in each case 2×1 liters are filtered in the course of 1 hour through the device according to the invention. The first liter of filter effluent was discarded, the second then served for measurement of ⁶⁰Co concentration. In table 1 hereinafter, YA is untreated circuit water of the primary circuit of a nuclear power plant, TC12 is a mixed bed without covering layer and, from May 29, 2007, was the device according to the invention having the abovenamed mixed bed and a covering layer of Lewatit® TP 207 MDS OH. The device according to the invention was not started until May 29, 2007 (2007-05-29). (See table 1)

TABLE 1

| | | Radioactivity in |
|---|---|---|
| Water studied | Date | Bq/m³ for ⁶⁰Co |
| TC12 without covering layer | 2007-05-10 | 1.00 · 10⁶ |
| YA | 2007-05-10 | 8.20 · 10⁶ |
| YA | 2007-05-14 | 5.90 · 10⁶ |
| TC12 without covering layer | 2007-05-15 | 3.00 · 10⁵ |
| YA | 2007-05-15 | 8.30 · 10⁶ |
| YA | 2007-05-16 | 6.20 · 10⁶ |
| YA | 2007-05-21 | 8.60 · 10⁶ |
| TC12 without covering layer | 2007-05-22 | 2.40 · 10⁵ |
| YA | 2007-05-22 | 9.00 · 10⁶ |
| YA | 2007-05-24 | 5.50 · 10⁶ |
| TC12 with covering layer | 2007-05-29 | 1.30 · 10⁵ |
| YA | 2007-05-29 | 9.80 · 10⁶ |
| YA | 2007-05-30 | 8.40 · 10⁶ |
| YA | 2007-05-31 | 1.50 · 10⁷ |
| YA | 2007-06-04 | 6.40 · 10⁶ |
| TC12 with covering layer | 2007-06-05 | 1.80 · 10⁵ |
| YA | 2007-06-05 | 7.20 · 10⁶ |
| YA | 2007-06-06 | 7.80 · 10⁶ |
| YA | 2007-06-11 | 8.90 · 10⁶ |
| YA | 2007-06-12 | 9.20 · 10⁶ |
| YA | 2007-06-14 | 1.00 · 10⁷ |
| TC12 with covering layer | 2007-06-14 | 1.40 · 10⁵ |
| YA | 2007-06-18 | 8.20 · 10⁶ |
| TC12 with covering layer | 2007-06-19 | 1.80 · 10⁵ |
| YA | 2007-06-19 | 8.00 · 10⁶ |
| YA | 2007-06-21 | 1.00 · 10⁷ |
| YA | 2007-06-25 | 8.50 · 10⁶ |
| YA | 2007-06-27 | 1.10 · 10⁷ |
| TC12 with covering layer | 2007-06-28 | 7.10 · 10⁵ |
| YA | 2007-06-28 | 9.60 · 10⁶ |
| YA | 2007-07-02 | 8.20 · 10⁶ |
| YA | 2007-07-05 | 7.70 · 10⁶ |
| YA | 2007-07-06 | 1.10 · 10⁷ |
| TC12 with covering layer | 2007-07-06 | 1.30 · 10⁵ |
| YA | 2007-07-09 | 1.20 · 10⁷ |
| TC12 with covering layer | 2007-07-10 | 1.60 · 10⁵ |
| YA | 2007-07-10 | 8.40 · 10⁶ |
| YA | 2007-07-12 | 9.70 · 10⁶ |
| YA | 2007-07-16 | 7.90 · 10⁶ |

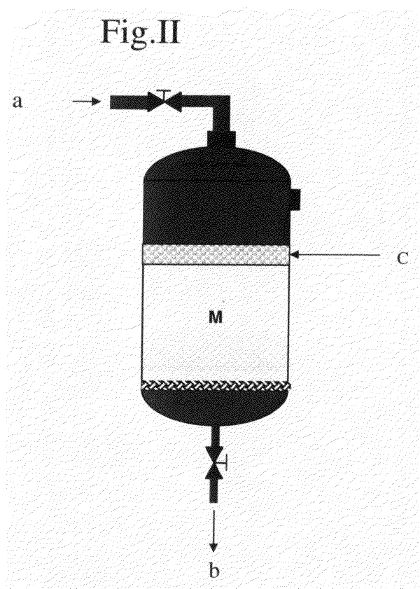

It can clearly be seen from the measurement data in table 1 how, by the use of a device according to the invention according to FIG. 2, the content of ⁶⁰Co has decreased from May 29, 2007. The experiments in the context of the present invention allow the speculation that the mode of action of the monodisperse, macroporous ion exchangers in the covering layer is not based in the actual ion exchange, but is also based in adsorption of colloidal radioactive particles.

The present invention has been described with reference to specific details of particular embodiments and examples thereof. It is not intended that such details be regarded as limitations upon the scope of the invention except insofar as and to the extent that they are included in the accompanying claims. As used in this specification and the appended claims, the singular forms “a,” “an,” and “the” include plural referents unless the content clearly dictates otherwise.

1. A process for the adsorption of radionuclides from a media, comprising:
providing a mixed-bed ion exchanger having a median bead diameter:
applying at least one covering layer to said mixed-bed ion exchanger, thereby forming a covered mixed-bed ion exchanger, wherein said at least one covering layer comprises a monodisperse, macroporous ion exchanger having a median bead diameter smaller than the median bead diameter of the mixed bed ion exchanger; and
contacting said covered mixed-bed ion exchanger with the media.

2. The process as claimed in claim 13, wherein the water or aqueous solution is from a nuclear plant, a nuclear power plant, a reprocessing plant, a nuclear enrichment plant or a medical facility.

3. The process as claimed in claim 1, wherein the monodisperse macroporous ion exchanger is a chelate resin or anion exchanger.

4. The process as claimed in claim 1, wherein the monodisperse, macroporous ion exchanger comprises particles having a median bead diameter of 250 to 450 μm.

5. The process as claimed in claim 1, wherein the monodisperse macroporous ion exchanger is a strongly basic, medium-basic or weakly basic anion exchanger.

6. The process as claimed in claim 1, wherein the mixed-bed ion exchanger consists of a gel-type anion exchanger and a gel-type cation exchanger.

7. The process as claimed in claim 1, wherein the radionuclides are selected from the group consisting of ²¹⁰Po, ²²⁰Ru, ²²⁶Ra, ²³²Th, ²³⁵U, ²³⁸U, ⁸⁵Kr, ¹³⁷Cs, ⁸⁹Sr, ⁹⁰Sr, ¹⁴⁰Ba, ⁹⁵Zr, ⁹⁹Mo, ¹⁰⁶Ru, ¹⁴⁴Ce, ¹⁴⁷Nd, ³¹P, ³²P, ⁵⁸Co, ⁶⁰Co, ¹¹⁰Ag, ⁵⁴Mn, ⁶⁵Zn, ¹⁸⁷W, ¹²²Sb, ¹²⁴Sb, ¹²⁵Sb, ¹⁹⁷Au, ¹⁹⁸Au, ¹³¹In, ⁹⁹Tc, ⁶⁴Cu, ¹⁹⁷Hg, ¹³¹I to ¹⁴²I, ⁵⁹Fe, ⁴⁰K, and ²⁴Na.

8. The process as claimed in claim 1, wherein the monodisperse macroporous ion exchanger has a pore volume of 0.1 to 2.2 ml/g.

9. The process as claimed in claim 8, wherein the monodisperse, macroporous ion exchanger is formed from the polymerization of at least one monomer and at least one crosslinker, and wherein the porosity is achieved by adding 40 to 150 parts by weight of porogen, based on 100 parts by weight of the sum of the monomer and the crosslinker.

10. The process as claimed in claim 6, wherein the anion exchanger has a degree of crosslinking of 4 to 10 and the cation exchanger has a degree of crosslinking of 6 to 16.

11. (canceled)

12. An apparatus comprising:
a mixed bed ion exchanger, said mixed-bed ion exchanger comprising a gel-type anion exchanger and a gel-type cation exchanger; and
adjacent to said mixed-bed ion exchanger at least one covering layer, said at least one covering layer comprising a monodisperse macroporous ion exchangers
wherein the mixed-bed ion exchanger and the monodisperse macroporous ion exchanger each have a median bead diameter and wherein the median bead diameter of said monodisperse macroporous ion exchanger is smaller than the median bead diameter of the mixed-bed ion exchanger.

13. The process according to claim 1, wherein said media is a water or an aqueous solution.

14. The process according to claim 1, wherein the monodisperse macroporous ion exchanger comprises particles having a median bead diameter of 330 to 640 μm.

15. The process according to claim 1, wherein the monodisperse macroporous ion exchanger has a pore volume of 0.4 to 1.8 ml/g.
